(19) United States
(12) Patent Application Publication
(10) Pub. No.: US 2007/0283802 A1
(43) Pub. Date: Dec. 13, 2007

(54) Pneumatic System with One or More Piston-Cylinder Arrangements

(76) Inventor: Per-Ake Wahlberg, Harads (SE)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/575,052

(22) PCT Filed: Sep. 28, 2005
(86) PCT No.: PCT/SE05/01423

§ 371 Date: Mar. 9, 2007

(30) Foreign Application Priority Data
Sep. 28, 2004 (SE) 0402334-7

(51) Int. Cl. F15B 15/22; F01B 25/16; F01B 7/00

(52) U.S. Cl. 91/166; 137/861; 91/167 R

(57) ABSTRACT

The present invention encompasses a pneumatic system (6) with a pressure source (8) adapted for generating a medium under pneumatic pressure, a control valve (2) coordinated with the pressure source, via a first conduit (A), a piston-cylinder arrangement or a “motor” (1), whose working chamber (1e) is coordinated, via a second conduit (B), with said control valve (2) and whose low-pressure or return chamber (1f) is coordinated, via a third conduit (C), with one side of a coupling arrangement (10A′) whose other side is coordinated, via a fourth conduit (D), with said pressure source (8). Said coupling arrangement (10A′) is in the form of a unit (10A) coordinated with the piston-cylinder arrangement (1) but discrete or separated from the piston-cylinder arrangement (1), Within said unit (10A) and extending between connections associated with the unit there is disposed at least one direct or indirect coupling-in of a high-pressure regulator (11) and a low-pressure regulator (12).

### TECHNICAL FIELD

The present invention relates in general to a pneumatic system, the system comprising int. al. one or more piston-cylinder arrangements or other similar arrangements, generically designated “motors”, where a piston unit in a selected embodiment will be reciprocally moveable within a cylinder unit by a pneumatic pressure medium put under excess pressure by means of a control valve. More particularly, the present invention relates to such a pneumatic system with a pressure source adapted for generating a medium under pneumatic excess pressure, a control valve coordinated with the pressure source, across or via a first conduit, in any event one piston-cylinder arrangement or a “motor” whose operating or working chamber is coordinated with said control valve, across or via a second conduit, and whose low-pressure or return chamber is coordinated, across or via a third conduit, with one side of a coupling arrangement whose other side is coordinated with said pressure source, across or via a fourth conduit.

The present invention is principally intended to be able to offer a coupling arrangement which is physically discrete and separate from a utilised, standardised piston-cylinder arrangement and which not only offers energy savings but also increased speed of the reciprocal motion of the piston unit.

More particularly, the present disclosure relates to the utilisation of a piston-cylinder arrangement where the piston unit is, by the intermediary of action from a control valve, by a system pressure acting within a working chamber, caused to move in a first direction and where a recuperation or return to a starting position on cessation of the above disclosed action, via the control valve, will take place automatically by an applied lower pressure acting in a low-pressure or return chamber.

Thus, the present invention will require access to a system for a pneumatic excess pressure, hereinafter referred as “system pressure” and access to a system for a pneumatic low-pressure, hereinafter referred to “low-pressure system”, where the system pressure will act within a working chamber during one stroke of the piston within the piston-cylinder arrangement, all while the pressure within the low-pressure system increases somewhat depending upon available volume of said low-pressure system, with a smaller increase in a larger volume and vice versa.

### BACKGROUND ART

Numerous different embodiments of methods and arrangements of the above-disclosed nature are previously known in the art.

As a first example of the state of the art, and the technical field to which the present invention relates, mention might be made of a single piston-cylinder arrangement, shown and described in greater detail in FIG. 1, the arrangement being actuable by means of a single control valve, where the control valve is adapted, in a first adjustment position, to permit the supply of hydraulic or pneumatic system pressure to a working chamber and thereby positively displace a piston unit (to the right) while a medium or an air volume, enclosed in the return chamber, will depart from this chamber to an open low-pressure system, here illustrated as atmospheric pressure, according as the volume in the working chamber increases.

Via said single control valve, it is now possible to cause it, assuming a second adjustment position, to supply hydraulic or pneumatic pressure to a return chamber which will then serve the purpose corresponding to a working chamber and thereby positively displace the piston unit (to the left) while an air volume, enclosed in the working chamber and now serving as the return chamber, departs from the return chamber to the low-pressure system, here illustrated as atmospheric pressure, according as the volume in the working chamber increases.

A piston-cylinder arrangement, connected in this manner and utilising a control valve constructed and connected in this manner, has proved to entail a control and operation under high losses and thereby displaying a low degree of efficiency.

As a second example of the state of the art, more focused on the technical field to which the present invention relates, mention might be made by referring to a piston-cylinder arrangement, shown in greater detail and described in FIG. 2, with a single control valve, where a return chamber of the piston-cylinder arrangement is inter-connected to a coupling arrangement.

This coupling arrangement will be pressurised by a control valve at the same time as pneumatic system pressure is supplied to the working chamber within the piston-cylinder arrangement and, as a result, a lower, but nevertheless increasing, pressure is built up in said return chamber, this pressure also being increased by the motion of the piston unit.

The coupling arrangement disclosed here displays, as a low-pressure system, a series connection of an accumulator tank, a low-pressure valve, a non-return valve and a throttle, all with the common purpose of permitting a damping control of the motion of the piston unit towards an end position for the stroke and, by the intermediary of an excess pressure supplied to the coupling arrangement within the low-pressure system, to return the piston unit to its starting position (shown in FIG. 2).

Observing the technical considerations, which are to be related to the basic preconditions for the present invention, mention might also be made, as part of the prior art, with reference to a piston-cylinder arrangement which is schematically illustrated and described in FIG. 3.

This piston-cylinder arrangement displays an extremely complex structure for the cylinder part or unit, which, with the aid of ducts in association with the cylinder, may form an accumulator tank for its low-pressure system, and with an array of ducts within the end piece or section of the cylinder unit, to be able to create the preconditions for introduction of a low-pressure regulator, a high-pressure regulator and an expansion space.

The practical construction of such a specifically designed and constructed piston-cylinder arrangement is illustrated more closely and described in Swedish Patent Publication Number SE-C2-510 463.

Reference is also made to the contents of the International Patent Application PCT/SE01/00589 (International Publication Number WO 01/73299 A1), in which it is disclosed a method and an energy-saving cylinder device of a single-acting type.

More specifically, this publication does reveal a method of in an energy-saving way operating a single-acting cylinder device provided with a return function, which comprises a cylinder part (2) with an interior cylinder serving duct (50) and a piston (4) arranged in a movable manner in the duct (50), said piston defining a working chamber (5) and a return chamber (6) in the duct (50) and executing a working stroke and a return stroke in the same, the method comprising the steps of;
causing a first fluid to flow into the working chamber (5) from a pressure source (39), which has an output pressure, and thereby operating the working stroke of the piston (4),
closing the return chamber (6), so that a second fluid in the return chamber (6) is compressed during the working stroke of the piston (4), and
opening the working chamber (5) after the working stroke, so that the first fluid is permitted to flow out of the working chamber (5) into the atmosphere and so that the second fluid compressed in the return chamber (6) returns the piston (4) during the return stroke.

As significant steps, related to that publication, it is suggested the step of reducing the pressure of the second fluid in the return chamber (6), if this pressure exceeds an upper pressure value, which is the pressure reached first of either the output pressure of the pressure source (39) or a maximum pressure value, which corresponds to a maximum permissible pressure in the return chamber (6) during operation.

### Consideration Related to the Present Invention Problem Structure

Considering the circumstance that the technical deliberations that must be made by a person skilled in the art to be able to offer a solution to one or more technical problems posed is, on the one hand, initially a necessary insight into the measures and/or sequence of measures to be adopted and, on the other hand, a necessary selection of the means required, the following technical problems are likely, in view hereof, to be relevant in the evolution of the subject matter of the present invention.

Considering the state of the art, as described above, it should therefore be seen as a technical problem to be able to realise the importance of, the advantages associated with and/or the technical measures and considerations which will be required in order to create a coupling arrangement which may offer the operational technical advantages which may be deemed to be related to the above-described construction but still be able to refrain from the constructional complexity of the piston-cylinder unit, according to the mentioned Swedish Patent Publication and/or according to the mentioned International Patent Publication, and where measures have been adopted which entail that this operational technical effect has been capable, in a simple manner, of being transferred to system constructions and couplings within a pneumatic system applicable to standardised single piston-cylinder arrangements, such as according to FIG. 1, utilising single control valves, and thereby be able to offer a piston-cylinder arrangement or motor displaying a simple and automatic return motion.

There resides a technical problem in being able to realise the importance of, the advantages associated with and/or the technical measures and considerations which will be required in order to create such preconditions that already installed piston-cylinder arrangement or arrangements, with associated control valve or valves, may readily be retrofitted, according to the disclosures of the present invention, by a simple coupling-in of a special unit, enclosing a coupling arrangement according to the present invention, and a simple supplementary provision of conduits, as well as a simple modification of the control valve.

There resides a technical problem in being able to realise the importance of, the advantages associated with and/or the technical measures and considerations which will be required in a pneumatic system with a pressure source adapted for generating a medium or air, which is under excess pressure and is utilised as a system pressure, a control valve coordinated with the pressure source, across or via a first conduit (tube or hose), one or more piston-cylinder arrangements or one or more “motors” whose working chamber is coordinated, across or via a second conduit, with said control valve and whose low-pressure or return chamber is coordinated, across or via a third conduit, with one side of a unitary coupling arrangement whose other side is coordinated, across or via a fourth conduit, with said pressure source, and where said coupling arrangement is to be in the form of a unit, which is pneumatically coordinated with the piston-cylinder arrangement but discrete and separate or separable from said piston-cylinder arrangement, where there is, within said unit and extending between connections associated with the unit, in any event one coordinated coupling-in of a high-pressure regulator and a low-pressure regulator.

Moreover, there resides a technical problem in being able to realise the importance of, the advantages associated with and/or the technical measures and considerations which will be required in a pneumatic system, where, during the time elapsed for a stroke, the coupling arrangement will be adapted so as to be able to offer a controlled compression of the medium within the low-pressure or return chamber by the observation of relevant static or dynamic conditions within the low-pressure system and its volume.

There resides a technical problem in being able to realise the importance of, the advantages associated with and/or the technical measures and considerations which will be required in a pneumatic system, where said piston-cylinder arrangement may each consist of a single standardised unit.

There resides a technical problem in being able to realise the importance of, the advantages associated with and/or the technical measures and considerations which will be required in a pneumatic system where a single standard safety valve is to be connected to a conduit, a fourth conduit, or the like.

There resides a technical problem in being able to realise the importance of, the advantages associated with and/or the technical measures and considerations which will be required in a pneumatic system, where said unit may display a compact coupling-in of a safety valve and a coupling-in of said high-pressure regulator and said low-pressure regulator.

There resides a technical problem in being able to realise the importance of, the advantages associated with and/or the technical measures and considerations which will be required in a pneumatic system where in an accumulator tank associated with the low-pressure side or the low-pressure system, may when necessary be directly or indirectly connected to a volume, serving as low-pressure or return chamber, for one or more piston-cylinder arrangements at rest or undergoing change.

There resides a technical problem in being able to realise the importance of, the advantages associated with and/or the technical measures and considerations which will be required in a pneumatic system where said high-pressure regulator may be adjustable to a maximum system-adapted low-pressure or return chamber related value, which is applicable at the end of a piston stroke.

There resides a technical problem in being able to realise the importance of, the advantages associated with and/or the technical measures and considerations which will be required in a pneumatic system, where said low-pressure regulator may be adjustable to a minimised, system-adapted value, which applies to a low-pressure or return chamber in conjunction with an initial piston stroke.

There resides a technical problem in being able to realise the importance of, the advantages associated with and/or the technical measures and considerations which will be required in a pneumatic system, where the high-pressure regulator may be adjustable manually and/or by the intermediary of a step motor.

There resides a technical problem in being able to realise the importance of, the advantages associated with and/or the technical measures and considerations which will be required in a pneumatic system, where the low-pressure regulator may be adjustable manually and/or by the intermediary of a step motor.

There resides a technical problem in being able to realise the importance of, the advantages associated with and/or the technical measures and considerations which will be required in a pneumatic system, where said coupling arrangement may be adapted to cause pressurisation of said low-pressure or return chamber before a first stroke, this latter being actuable by the action of said control valve.

There resides a technical problem in being able to realise the importance of, the advantages associated with and/or the technical measures and considerations which will be required in a pneumatic system, where said safety valve may consist of a non-return valve adapted, in the event of an emergency stop, rapidly to bleed the system of air.

There resides a technical problem in being able to realise the importance of, the advantages associated with and/or the technical measures and considerations which will be required in a pneumatic system, where an accumulator tank, associated with a coupling arrangement, is to be incorporated in said unit, or alternatively coupled into said third conduit as a complement to the accumulator tank-like effect which the low-pressure or return chamber of the piston-cylinder arrangements gives to a utilised low-pressure system.

There resides a technical problem in being able to realise the importance of, the advantages associated with and/or the technical measures and considerations which will be required in a pneumatic system, where a selected number of separately controlled piston-cylinder arrangements may, as regards their low-pressure or return chamber, be coordinated with and connected to one and the same low-pressure system and one and the same coupling arrangement.

There resides a technical problem in being able to realise the importance of, the advantages associated with and/or the technical measures and considerations which will be required in a pneumatic system, where a selected number of first, separately controlled piston-cylinder arrangements may, as regards their low-pressure or return chamber, be coordinated with and connected to one and the same first coupling arrangement, dimensioned and adapted to each one of said utilised piston-cylinder arrangements and their mutual positions as well as relevant conditions prevailing within the low-pressure system.

There also resides a technical problem in being able to realise the importance of, the advantages associated with and/or the technical measures and considerations which will be required in a pneumatic system, where a selected number of other, separately controlled, piston-cylinder arrangements will be able, as regards their low-pressure or return chambers, to be coordinated with and connected to one and the same other coupling arrangements, dimensioned and adapted to said piston-cylinder arrangement and their mutual positions as well as relevant conditions prevailing within the low-pressure system.

There resides a technical problem in being able to realise the importance of, the advantages associated with and/or the technical measures and considerations which will be required in a pneumatic system where all piston-cylinder arrangements coordinated to one coupling arrangement should be dimensioned equally or in any event substantially equally.

Solution

The present invention thus takes as its point of development the state of the art, as disclosed by way of introduction in respect of a pneumatic system, with a pressure source adapted for generating a medium or air placed under pneumatic pressure, a control valve coordinated with said pressure source, across or via a first conduit, in any event one piston-cylinder arrangement or one “motor” whose working chamber is coordinated, across or via a second conduit, with said control valve and whose low-pressure or return chamber is coordinated, across or via a third conduit, with one side of a coupling arrangement whose other side is coordinated with said pressure source, across or via a fourth conduit.

In order to be able to solve one or more of the above-outlined technical problems, the present invention in particular discloses that the prior art is to be supplemented by causing the coupling arrangement to be in the form of a unit, pneumatically coordinated with the piston-cylinder arrangement but nevertheless physically discrete and separate from said piston-cylinder arrangement, and that there is disposed, within said unit and extending between connections associated with said unit, in any event one direct or indirect coupling-in of a high-pressure regulator and a low-pressure regulator.

In addition the present invention suggests that, during the time elapsed for a stroke, the coupling arrangement will be adapted so as to be able to offer a controlled compression of the medium or air, within the low-pressure or return chamber by the observation of relevant static or dynamic conditions within said low-pressure system or a volume of a tank, designated as an accumulator tank.

As proposed embodiments, falling within the scope of the fundamental concept of the present invention, it is disclosed that said piston-cylinder arrangement may advantageously consist of a single, such as a standardised, piston-cylinder unit.

It is further disclosed that a safety valve be connected to a conduit, a fourth conduit, or the like.

Said unit should advantageously display a parallel coupling of a safety valve and a coordinated coupling-in of said high-pressure regulator and said low-pressure regulator.

It is further disclosed that an accumulator tank, related to the low-pressure system, may, when necessary, be directly or indirectly connected to one or more low-pressure or return chambers, disposed at one or more piston-cylinder arrangements.

Said high-pressure regulator should advantageously be adjustable to a value adapted to a low-pressure system, applying at the end of a piston stroke.

Said low-pressure regulator should be adjustable to a value adapted to a low-pressure system valid for the low-pressure or return chamber in conjunction with an initial piston stroke.

The high-pressure regulator should be adjustable to its allocated limit value manually and/or by the intermediary of a step motor.

The low-pressure regulator should be adjustable to its allocated limit value manually and/or by the intermediary of a step motor.

Said coupling arrangement is adapted to allow pressuration of the low-pressure system and thereby causing said low-pressure or return chamber, prior to a first piston stroke, to be activated by the intermediary of the action of said control valve.

During time intervals for a piston stroke, the coupling arrangement is adapted to be able to offer controlled compression of the medium or air within the low-pressure system and its low-pressure or return chamber.

Said high-pressure regulator is adapted to permit the presetting of a valid active maximised pressure for the low-pressure system and its low-pressure or return chamber, at the end of the piston stroke.

Said low-pressure regulator is adapted to allow the presetting of a valid active minimised pressure for the low-pressure system and its low-pressure or return chamber, at the beginning of the piston stroke.

Further, a coupled-in safety valve should consist of a non-return valve adapted, in the event of an emergency stop, to bleed the system of air.

An accumulator tank provided for the low-pressure system and related to the coupling arrangement may be incorporated in said unit or alternatively coupled in as a separate unit to a conduct, such as said third conduit.

A selected number of separate, controlled piston-cylinder arrangements are, in respect of their low-pressure or return chamber, provided for the low-pressure system, coordinated with one and the same coupling arrangement.

A selected number of first, separately controlled, piston-cylinder arrangements are, in respect of their low-pressure or return chambers, provided for the low-pressure system, coordinated and connected to one and the same first coupling arrangement.

A selected number of second, separately controlled, piston-cylinder arrangements are, in respect of their low-pressure or return chambers, provided for the low-pressure system, coordinated and connected to one and the same second coupling arrangement.

All piston-cylinder arrangements, coordinated to one and the same coupling arrangement, may advantageously be dimensioned identically or in any event substantially identically.

Advantages

The advantages which may principally be deemed to be associated with the present invention and the thereby disclosed specific significative characterising features are that there have hereby been created preconditions for being able to render considerably more efficient the operation of one or more standardised piston-cylinder arrangements with a control valve coupled thereto by simple coupling-technical complements and the coupling-in of a separate unit, containing a coupling arrangement with access to a low-pressure regulator and a high-pressure regulator, as well as the utilisation of a safety valve within a low-pressure or return conduit.

### BRIEF DESCRIPTION OF THE ACCOMPANYING DRAWINGS

Prior art constructions and currently proposed embodiments, displaying the significative characterising features, associated with the present invention, will now be described in greater detail hereinbelow, for the purposes of exemplification and with reference to the accompanying Drawings. In the accompanying Drawings:

FIG. 1 shows the prior art fundamental construction of a standardised piston-cylinder arrangement with an associated control valve and where the one adjustment position of the control valve gives a displacement effective by a system pressure of the piston unit in a first direction (to the right) while the other adjustment position of the control valve gives a displacement, effective by the system pressure, of the piston unit in a second, opposing direction (to the left) while an air volume, enclosed in a return chamber, is allowed under throttle to pass out to atmospheric pressure;

FIG. 2 shows a prior art construction of a coupling arrangement related to a piston-cylinder arrangement with a series connection from a return chamber of an accumulator tank, a low-pressure valve, a non-return valve and a throttle, and where this coupling arrangement is supplied with a reduced system pressure to the return chamber at the same time as the working chamber is supplied with a system pressure by the intermediary of the action of one and the same control valve, and there have thereby been created the preconditions for, at the end of a piston stroke, via a selected excess pressure in the accumulator tank and the return chamber, to cause the piston unit to return to its starting position, in accordance with that described and illustrated in Patent Publication DE-32 33 739-A1;

FIG. 3 illustrates and describes as a prior art a simplified coupling arrangement integrated coordinatingly with a specially constructed piston-cylinder arrangement and where a low-pressure regulator and a high-pressure regulator are integrated within a cylinder portion, in order to control the reciprocating movement of a piston unit, in accordance with that which is described and illustrated in Patent Publication SE-C2-510 465;

FIG. 4 illustrates and describes a standardised piston-cylinder arrangement which has been supplemented with a unit-related coupling arrangement, in accordance with the present invention;

FIG. 5 illustrates and describes a system with five piston-cylinder arrangements coordinated with a low-pressure system constructed with access to each return chambers and with a single coupling arrangement, in accordance with the present invention;

FIG. 6 illustrates and describes a system with three different sets of piston-cylinder arrangements, where each one of these is coordinated with its allocated coupling arrangement and where the low-pressure system utilises the free volume accessible by the intermediary of the return chambers and a coupled-in accumulator tank;

FIG. 7 is a side elevation, partly in section, of a coupling arrangement coordinated to a unit, in accordance with the disclosures of the present invention;

FIG. 8 is a plan view of the unit shown in FIG. 7;

FIG. 9 is a side elevation and cross section of the arrangement and construction for a high-pressure regulator, included in the unit, according to the present invention, but with the upper portion removed, given that its construction and function are apparent from FIG. 10;

FIG. 10 is a side elevation and cross section of the arrangement and construction for a low-pressure regulator, included in the unit according to the present invention;

FIG. 11 illustrates in greater detail the coordination between the high-pressure regulator, the low-pressure regulator and a non-return valve serving as a safety valve;

FIG. 12 also shows the coordination of the high-pressure regulator, the low-pressure regulator and the safety valve, according to FIG. 11; and

FIG. 13 shows one preferred coupling-in of a valve serving as an emergency stop.

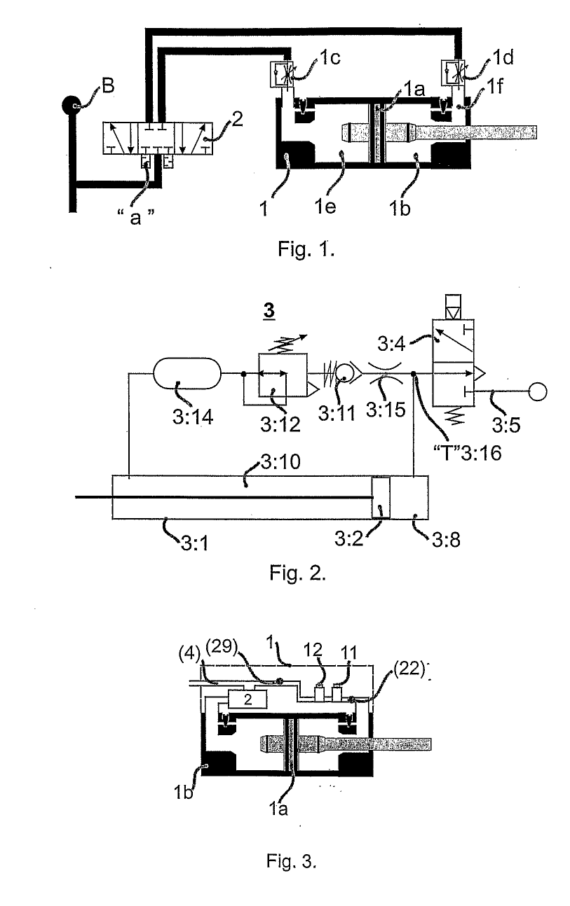

### DESCRIPTION OF THE PRIOR ART, IN ACCORDANCE WITH FIGS. 1, 2 AND 3

As regards the prior art, illustrated in the appended Figures, FIG. 1 illustrates the prior art fundamental construction of a standardised piston-cylinder arrangement 1 with associated control valve 2 and where the one adjustment position of the control valve gives a displacement of a piston unit or a piston member 1 a in a first direction (to the right in FIG. 1), while the second adjustment position of the control valve gives a displacement of the piston unit or the piston member 1a in a second, opposing direction (to the left in FIG. 1), relating to a fixed cylinder unit or a cylinder member 1b.

The inlet and outlet of the arrangement 1 are each provided with a throttle and one-way valve 1c, 1d so that it will not be possible for the system pressure to act with full force on the piston member la within the working chamber 1e without an established pre-set counter pressure in the return chamber 1f.

This circumstance is part of the prior art domain and will not, therefore, be described in detail.

The arrangement 1 is here of a construction, where the motion of the piston member 1a (to the right) requires pneumatic pressure in the working chamber 1e and where the return chamber 1f is in throttled cooperation with the atmosphere “a” and its pressure by the intermediary of the control valve 2.

FIG. 2 illustrates and describes the construction of a coupling arrangement 3 related to a piston-cylinder arrangement, designated 3:1.

The coupling arrangement 3 may here be considered as comprising, counting from the return chamber 3:10, a series coupling of an accumulator tank 3:14, a low-pressure valve 3:12, a non-return valve 3:11 and a throttle 3:15 and, as a result, this coupling arrangement 3 will be progressively supplied with a reduced system pressure at the same time as the working chamber 3:8 is directly supplied with the system pressure 3:5 by the intermediary of the action of one and the same control valve 3:4.

There have thereby been created the preconditions for, at the end of a piston stroke, via a selected excess pressure in the return chamber 3:10 and in the accumulator tank 3:14, returning, under a pressure reduction, the piston unit 3:2 back to its starting position, in accordance with that which is illustrated and described in Patent Publication DE-32 33 739-A1.

More specifically, it may be ascertained that the coupled-in non-return valve 3:11 will not serve as a safety valve in accordance with the preconditions for the present invention, and that a “T” coupling 3:16 is utilised in order simultaneously to distribute the system pressure direct to the working chamber 3:8 and via the throttle 3:15 to the coupling arrangement 3.

Referring to FIG. 3, this Figure illustrates and schematically describes an alternative coupling arrangement, coordinated with an extremely complicated and specially constructed piston-cylinder arrangement 1, and where a low-pressure regulator 12 and a high-pressure regulator 11 are structured and integrated with a cylinder part or unit 1b, in order to control the reciprocating movement of a piston member or a piston unit 1a in accordance with that which is described and illustrated in greater detail in Patent Publication SE-C2-510 465.

More particularly, this relates to a method and an apparatus for being able to eliminate the occurrence of so-called “piston rod racing” at the first piston stroke in various types of pneumatically reciprocating piston members included in a piston-cylinder arrangement or “motor”, and where the working chamber and return chamber are usually at atmospheric pressure.

The utilisation is here proposed of a pressure regulator, connected to a pressure medium source (4) which, via a shunt (29), is disposed to be able to be connected to the return chamber of the pneumatic “motor”.

This regulator is designed so that, on the application of compressed air (4), it allows the opening of the shunt (29) into the return chamber so that this is automatically pressurised at the same time as the working chamber is placed under fall working pressure.

The pressure regulator will now close (22) the above-mentioned shunt (29) as soon as a desired pressure has been reached in the return chamber.

### Description of Currently Proposed Embodiment

It should be emphasized by way of introduction that, in the following description of a currently proposed embodiments which display the significative characterising features related to the present invention and which is clarified by means of the figures, shown in the accompanying Drawings, we have selected terms and special terminology with the intention principally of clarifying the inventive concept.

However, in this context it should be observed that the expressions selected here should not be considered as restrictive exclusively to the terms selected and utilised here but it should be understood that each thus selected term is to be interpreted so that, in addition, it encompasses all technical equivalents which function in the same or substantially the same manner in order thereby to be able to attain the same or substantially the same intention and/or technical effect.

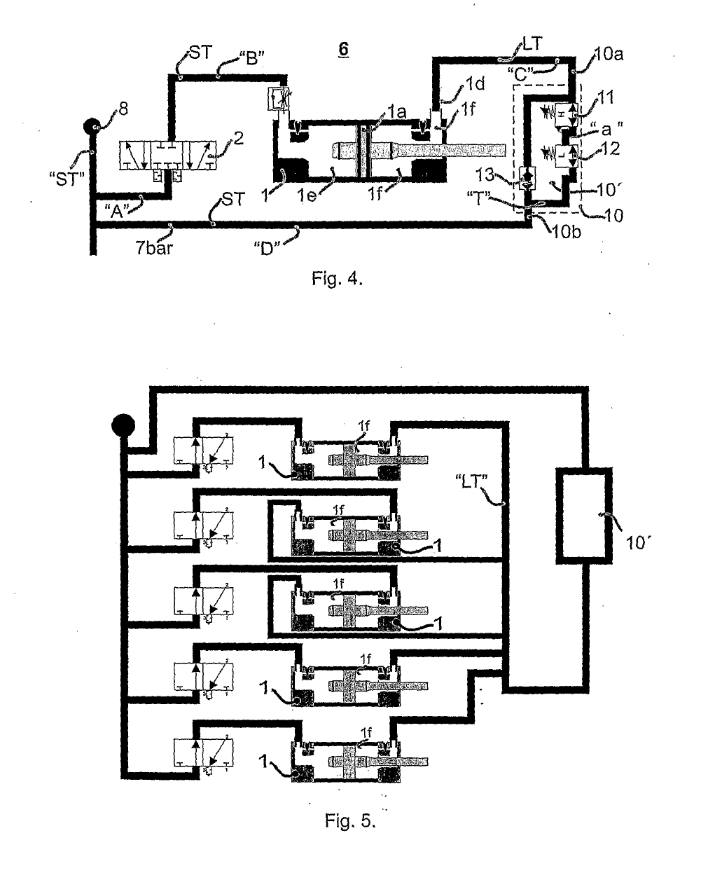

With reference to FIG. 4, this Figure thus schematically illustrates the fundamental preconditions for the present invention and where the significative properties associated with the present invention have been given general concrete form by one now proposed embodiment of the present invention described in greater detail hereinbelow.

Thus, FIG. 4 is intended to illustrate a utilised pneumatic system 6 with a pressure source 8 adapted for generating a medium or air under pneumatic pressure, in the form of a system air pressure “ST”, set at 7 bar, a control valve 2 coordinated with the pressure source 8, across or via a first conduit “A ”, a piston-cylinder arrangement or a “motor” 1, whose working chamber 1e is coordinated with said control valve 2, across or via a second conduit “B”, and whose return chamber 1f is coordinated, across or via a third conduit “C”, with a low-pressure system “LT”, coordinated with one side of a coupling arrangement 10′, whose other side is coordinated, across or via a fourth conduit “D”, with said pressure source 8 and said system pressure “ST”.

Said coupling arrangement 10′ is given the form of a unit 10 coordinated pneumatically with the piston-cylinder arrangement 1 but discrete and physically separated from the piston-cylinder arrangement.

Within said unit 10 and extending between connections 10a, 10b associated with the unit there is disposed in any event one coupling-in of a high-pressure regulator 11 and a low-pressure regulator 12, whose characteristics will be described in greater detail hereinbelow with reference to FIGS. 9, 10 and 12.

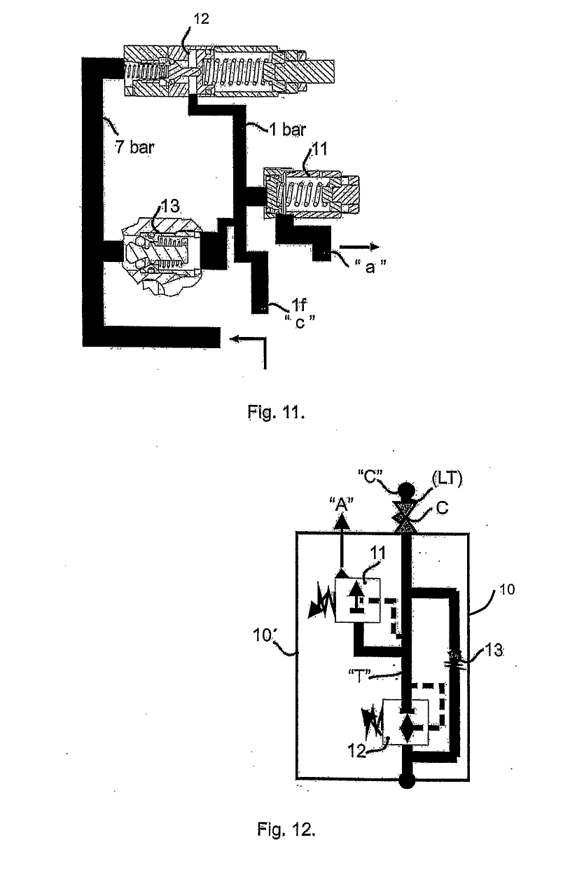

However, it might be mentioned already at this stage that the utilised high-pressure regulator 11 (see FIGS. 11 and 12) should be directly coupled-in to a conduit, designated “C”, and a low-pressure regulator 12 series-connected to said conduit “C”, the regulator being coupled, by the intermediary of a conduit “D”, to the system pressure “ST” or source 8.

Naturally, the coupling-in may also be put into effect by the intermediary of a separate conduit with a “T” junction, designated “T”. The low-pressure regulator 12 is to be connected direct to the pressure side “D” of the system and measure the pressure between the output of the low-pressure generator 12 and the low-pressure chamber 1f of the system.

The high-pressure regulator 11 is connected after the low-pressure regulator 12 to its own duct which communicates the regulator with the low-pressure conduit “C”.

A non-return valve 13 may be placed before or after the high-pressure regulator 11, but must be placed in the conduit between the outgoing pressure in the low-pressure regulator 12 and the low-pressure chamber 1f of the system.

Said piston-cylinder arrangement 1 may advantageously consist of a single standardised unit.

Once again, referring to FIG. 4, it will be apparent that a safety valve 13 is connected to said fourth conduit “D” or by corresponding means.

Said unit 10, with its associated coupling arrangement 10′, displays more particularly a parallel coupling of a safety valve 13 with a series coupling of said low-pressure regulator 12 and said high-pressure regulator 11, whose outlet may be opened to the atmosphere “a”.

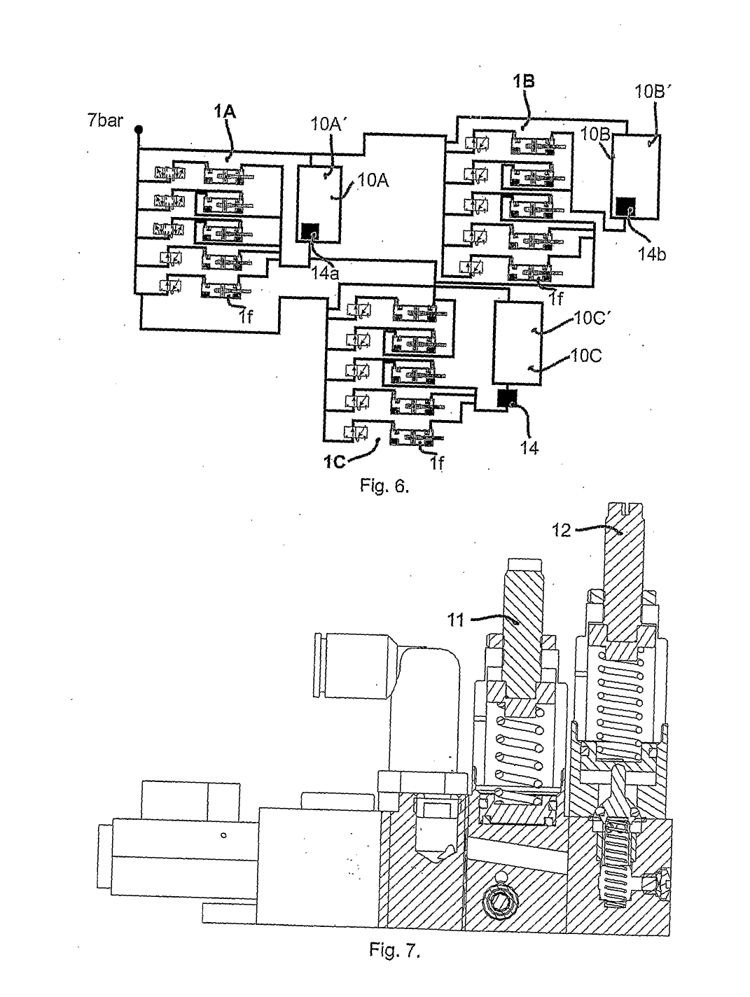

An accumulator tank 14 (FIG. 6) is directly or indirectly connected to the low-pressure system “LT” by the intermediary of one or more low-pressure or return chambers 1f.

Said high-pressure regulator 11 is adjustable to a low-pressure system-adapted value valid at the end of a piston stroke.

Said low-pressure regulator 12 is adjustable to a low-pressure system-adapted value, valid for the low-pressure or return chamber 1f, in conjunction with a piston stroke.

The high-pressure regulator 11 is adjustable manually and/or by the intermediary of a step motor, and the low-pressure regulator 12 may also be adjustable manually and/or by the intermediary of another step motor.

Said coupling arrangement 10′ is adapted to be pressurised by the intermediary of the low-pressure or return chamber 1f before a first piston stroke, this latter being activated by the intermediary of the action of said control valve 2.

During a time interval for one piston stroke, the coupling arrangement 10′ is adapted to be able to offer a controlled compression of the medium (the air) within the low-pressure system “LT” with associated accumulator tank 14, 14a and 14b, respectively, including one or more or coordinated with the volume related to one or more low-pressure or return chambers 1f.

Said high-pressure regulator 11 is adapted to permit presetting of an actively maximised pressure valid for the low-pressure system, with one or more return chambers 1f, at the end of the piston stroke. Occurring excess pressure is allowed to pass to the atmosphere “a”.

Said low-pressure regulator 12 is adapted to permit presetting of an actively minimised pressure valid for the low-pressure system, with one or more return chambers 1f, at the beginning of the piston stroke.

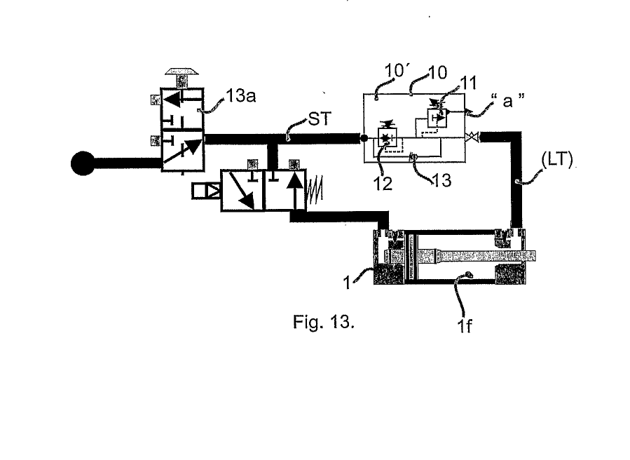

Said safety valve 13 consists of a non-return valve adapted, on activation of an emergency stop, to permit a bleeding of the system of air via a valve 13a (see FIG. 13).

Said accumulator tanks 14a, 14b (10A: 10B) related to the unit 10 and the coupling arrangement 10′ are integrated in said unit 10 or alternatively coupled-in to said third conduit “C” and the low-pressure system “LT”.

A selected number (five) of separately controlled piston-cylinder arrangements 1 in FIG. 5 are, as regards their allocated low-pressure system “LT” which is here limited to the free space for the low-pressure or return chambers 1f, coordinated with one and the same unit 10 and one and the same coupling arrangement 10′.

FIG. 6 then illustrates that a selected number of a first set of separately controlled piston-cylinder arrangements 1A are, as regards their low-pressure or return chamber 1f and accumulator tank 14a, coordinated and connected to one and the same first coupling arrangement 10A′ within a first unit 10A.

A selected number of a second set of separately controlled piston-cylinder arrangements 1B are, as regards their low-pressure or return chamber 1f and accumulator tank 14b, coordinated and connected to one and the same second coupling arrangement 10B′ within a second unit 10B.

All piston-cylinder arrangements 1A and 1B, respectively, associated with a coupling arrangement and coordinated with associated units 10A and 10B, respectively, are dimensioned identically or in any event substantially identically.

Thus, FIG. 4 illustrates and describes a single standardised piston-cylinder arrangement 1 (cf. the embodiment illustrated in FIG. 1) which has been supplemented with a single unit-related coupling arrangement 10′, in accordance with the present invention.

FIG. 5 illustrates and describes a system with five identical piston-cylinder arrangements 1, coordinated with a single coupling arrangement 10′, in accordance with the present invention.

FIG. 6 illustrates and describes a system with three different sets of mutually identical piston-cylinder arrangements 1A, 1B and 1C, where each one of them is coordinated with its allocated coupling arrangement 10A′, 10B′ and 10C′.

FIG. 7 shows in side elevation and partly in section a coupling arrangement 10′ coordinated to one unit 10, in accordance with the disclosures of the present invention.

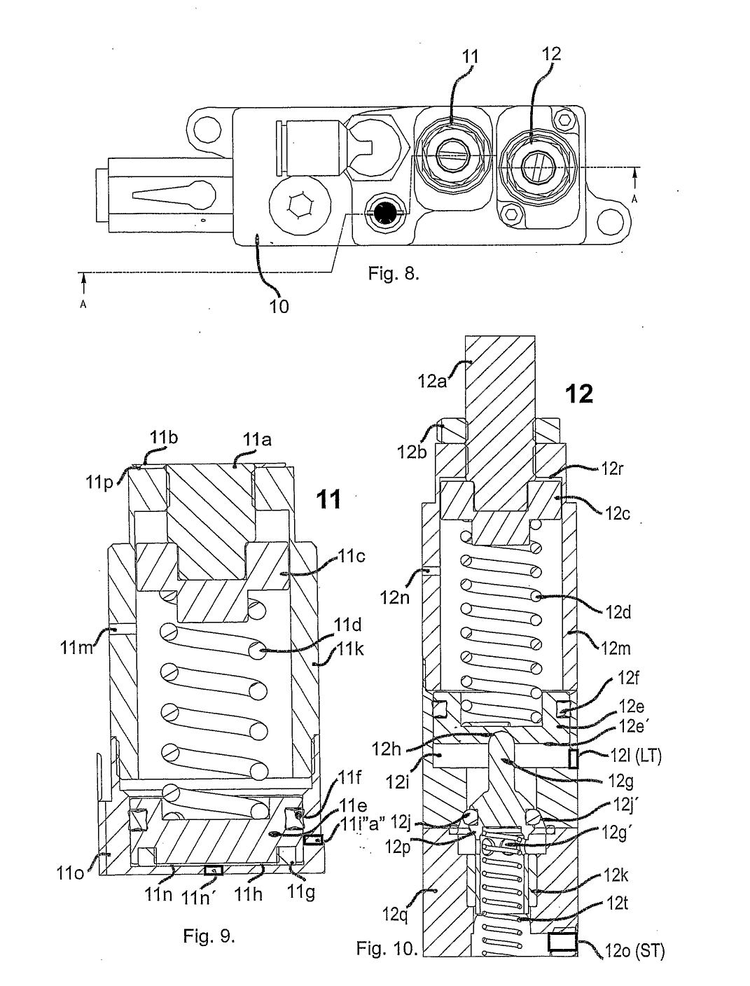

FIG. 8 shows the unit 10, according to FIG. 7, in plan view, while FIG. 9 shows, in side elevation and in section, a high-pressure regulator 11, included in the unit 10 according to the invention, while FIG. 10 shows in side elevation and in section a low-pressure regulator 12 included in the unit 10, according to the invention.

The High-Pressure Regulator 11 (FIG. 9)

This high-pressure regulator 11 displays an adjustment screw 11a (not shown) for presetting of a highest permitted pressure in the low-pressure system.

This adjustment may be put into effect manually and with a locking function with the aid of a locking nut 11b or by regulation by different types of motor power.

A sliding/guide washer 11c affords low friction against a spring 11d on rotation of the adjustment screw 11a.

The spring 11d is adapted for a pressure regulation against a piston 11e.

The piston 11e is adapted for a fixing of the spring 11d together with a QUAD-ring 11f as well as an edge seal ring 11g.

The combination between the spring force in the spring 11d and the pressure surface 11h in the piston 11e entails that, when the current maximum low-pressure in the low-pressure chamber 1f or the low-pressure system “LT” exceeds the spring force 11d, leakage will occur between the sealing surface in the edge seal ring 11g and the parallel surfaces of the block construction 11o.

The edge seal ring 11g constitutes a sealing ring or gasket usable for creating as slight resilience as possible on bleeding of the system via a channel 11i.

Said QUAD-sealing ring 11f is a gasket or sealing ring which is employed for centring the piston 11e with the lowest possible friction and a sealing against a chamber surrounding the spring unit 11d.

An air bleeder channel 11j to the atmosphere “a” of excess pressure in the high-pressure regulator 11 utilises a channel 11i, which is located between the edge seal ring 11g and the QUAD-ring 11f.

Reference numeral 11k illustrates a casing or a body for the regulator.

Bleeder holes 11m are adapted for a pressure increase/pressure reduction within the body 11k.

The pressure from the low-pressure system acts on the pressure surface 11n by the intermediary of a channel 11n′ and is affected by the pressure of the low-pressure chamber as well as the spring force in the spring 11d.

The adjustment screw 11a is bottomed against an edge 11p on delivery, in which event the cylinder arrangements are run and adjustment screw 11a opened until an excess pressure occurs and bleeding of air to the atmosphere “a” takes place through the channel 11i. Thereafter, the locking nut 11b is locked and the system has been finely tuned.

The Low-Pressure Regulator 12 (FIG. 10)

With reference to FIG. 10, this Figure shows in section the construction of the low-pressure regulator 12.

An adjustment screw 12a is shown here for setting of the lowest permitted pressure in the low-pressure system LT of the system.

Adjustment may be put into effect manually and with locking by means of a locking nut 12b or regulation by different types of motor power.

Reference numeral 12c discloses a sliding/guide washer with low friction against a spring 12d for an adapted pressure regulation on rotation of the adjustment screw 12a.

A piston 12e is adapted for a fixing of a spring 12d and cooperates with a QUAD-ring 12f and supports against a high-pressure stub shaft 12g.

The combination effect, between the spring force from the spring 12d and a recess 12h in the piston 12e, entails that, when the current lowest pressure is overcome by the spring force in the spring 12d in the low-pressure chamber 12i of the system, a sealing ring 12j opens against a pressure surface 12j′ and system pressure is supplied to the low-pressure chamber until the force of the piston surface overcomes the spring force 12d and closes the supply of system pressure “ST” via a channel 120.

The high-pressure stub shaft 12g holds the sealing ring 12j fixed in its valve seat 12j′.

The sealing stub shaft 12b is guided by a centring 12h in the lower part of the piston 12e serving as a recess.

A lower part is guided with the aid of a bushing 12k.

The stub shaft 12g also has a number of bores 12g′ uppermost above the bushing 12k for maximising the air flow.

As a result of this design, a very rapid aeration of the system is created. This also controls the balance in the regulator. This design of the low-pressure regulator 12 creates major possibilities for rapid air change in the low-pressure chamber of the low-pressure system.

The QUAD-ring sealing gasket 12f is employed for centring of the piston 12e and also for affording the lowest possible friction.

A channel 12l offers a pressure boost to the low-pressure system and its low-pressure chamber.

Reference numeral 12m is intended to illustrate a casing or a body for the regulator unit 12.

One or more bleeder holes 12n are adapted for a pressure boost/pressure reduction of the pressure inside the body 12m.

The system pressure “ST” acts, via an opening or channel 120 and in a closed regulator a system pressure is created against a surface 12p as well as the outer surface of the stub shaft below the sealing ring 12j, which keeps the regulator closed. When the pressure against the piston surface 12p is reduced, the spring force increases in the spring 12d and the valve opens.

The pressure surface 12e′ for the piston 12e is affected by the pressure of the low-pressure system “LT”, the spring force in the spring 12d, as well as the action of the system pressure through the surface 12p and the outside of the stub shaft.

Reference numeral 12q illustrates a block construction.

The adjustment screw 12a is unscrewed to a maximum position to an abutment against the edge 12r on delivery, the cylinder arrangement is run and the adjustment screw 12a closed until the load in the working equipment of the low-pressure chamber is homed, i.e. a cylinder with a suspended load is to lift a load to the home position. Thereafter, the lock nut 12b is locked and the system is finely tuned.

The design of the sealing gasket or ring 12j is as a square, but with the upper and lower outer sides rounded off. This rounding-off is so as to create an improved sealing configuration against the sealing surface 12j′.

The task of the bushing 12k is to hold the high-pressure stub shaft in a centred position.

The spring 12t serves the purpose of holding the upper rounded-off portion of the high-pressure stub shaft 12g against a depression 12h belonging to the piston.

The purpose of the chamber 12i is to guide the force of the piston 12e against the spring 12d so that the supply of an increased system pressure may take place to the low-pressure system “LT”.

The upper rounded-off comers of the sealing ring or gasket 12j create an abutment against a rounded-off sealing surface 12j′.

The air speed may be increased or reduced by changing the angle of the walls of the air intake or the seat.

When the regulator opens, the system pressure “ST” flows through the channel 12o in order to create a more rapid air flow to the low-pressure system “LT”.

When the valve is closed, the system pressure “ST” lies against a surface 12p as well as the inner surface of the stub shaft below the sealing ring 12j.

The system pressure passes through a first channel, through a second channel outside the sealing ring 12j to the low-pressure chamber of the system.

Referring to FIG. 11, this Figure schematically illustrates the interconnection of the high-pressure regulator 11, the low-pressure regulator 12 and the non-return valve 13 and also illustrates how an excess pressure in the high-pressure regulator 11 is to be led to the atmosphere “a”.

FIG. 12 illustrates that the arrangement 10′ is pressurised via an open emergency stop valve 13a and a conduit “ST” and the low-pressure system is activated via conduit “LT”.

Bleeding of the system pressure “ST” through a change of the position in the valve 13a.

In that the system pressure “ST” falls, the non-return valve 13 opens and bleeds the low-pressure system “LT”.

1f an excess pressure occurs in the low-pressure chamber 1f, which exceeds the system pressure “ST”, the non-return valve 13 opens and releases back the excess pressure through the system conduit “ST” back to a tank 14.

Bleeding to the atmosphere “a” takes place to a limited degree through the high-pressure regulator 12 in the block 10.

The bleeder conduit of the high-pressure regulator to the atmosphere “a” is extremely limited in diameter, to the remaining dimensions in block 10.

The bleeder conduit 11of the high-pressure regulator to the atmosphere “a” is extremely limited in diameter, in response to other dimensions. This is because the high-pressure regulator 11 should only take care of leakage over the piston of the cylinder.

The features reflected in the characterizing section of the claims offer basic condition for group coordinate piston-cylinder arrangements, whereby said group is put under pressure before the system is activated, as illustrated above.

The consequences of this are that each piston-cylinder arrangement within a group may be under its own compression state, which is controllable via a variable tank volume and that groups of piston-cylinder arrangements may be coordinated with different tank volumes.

This coordination of piston-cylinder arrangements and the controlled compression rate offer the benefit that said arrangements may expose different compression rates during working stroke and return stroke.

This offers the benefit that each individual arrangement and its piston stroke may be controlled.

The invention may offer the possibility that three arrangements “expand”, is displaced, while one arrangement “compresses”, is returned, one arrangement “expands” while four “compress”.

The practical application of this coordination is that when all arrangements within a group “expand” simultaneously there is required a larger tank volume for causing one stroke, however, if said arrangements are controlled in a manner where only one arrangement shall “expand”, then the remaining arrangements within the group are part of the required tank volume.

The practical application, however, requires an adjustment of the force required, as the force within the compression must be adapted to the relevant and required force.

The present invention is naturally not restricted to the embodiment described above by way of example but may undergo modifications without departing from the inventive concept as defined in the appended claims.

In particular, it should be observed that each illustrated unit and/or circuit may be combined with every other illustrated unit and/or circuit within the framework of being able to attain the desired technical function.

What is claimed is:

1. A pneumatic system with a pressure source adapted for generating a medium or air under pneumatic pressure, a control valve coordinated with the pressure source, via a first conduit, a piston-cylinder arrangement or a “motor” whose working chamber is coordinated, via a second conduit, with said control valve and whose low-pressure or return chamber is coordinated, via a third conduit, with one side of a coupling arrangement whose other side is coordinated, via a fourth conduit, with said pressure source, characterised in that said coupling arrangement is in the form of a unit coordinated with said piston-cylinder arrangement but discrete or separated from the piston-cylinder arrangement, that, within said unit and extending between connections associated with said unit, there is disposed in any event one direct or indirect coupling-in of a high-pressure regulator and a low-pressure regulator, and that during a time interval for one piston stroke, the coupling arrangement is adapted to be able to offer a controlled compression of the medium within a return chamber, related to a system adapted volume of a tank.

2. The system as claimed in claim 1, characterised in that said piston-cylinder arrangement consists of a single standardised unit.

3. The system as claimed in claim 1, characterised in that a safety valve is connected to said fourth conduit.

4. The system as claimed in claim 1, characterised in that said unit displays a coupling-in of a safety valve and a series coupling of said high-pressure regulator and said low-pressure regulator.

5. The system as claimed in claim 1, characterised in that an accumulator tank is directly or indirectly connected to a return chamber.

6. The system as claimed in claim 1, characterised in that said high-pressure regulator is adjustable to a system-adapted value, applicable at the end of a piston stroke.

7. The system as claimed in claim 1, characterised in that said low-pressure regulator is adjustable to a system-adapted value, applicable for the return chamber in conjunction with a piston stroke.

8. The system as claimed in claim 6, characterised in that the high-pressure regulator is adjustable manually and/or by the intermediary of a step motor.

9. The system as claimed in claim 7, characterised in that the low-pressure regulator is adjustable manually and/or by the intermediary of a step motor.

10. The system as claimed in claim 1, characterised in that said coupling arrangement is adapted to permit pressurising of said return chamber before a first piston stroke by the intermediary of the action of said control valve.

11. The system as claimed in claim 1, characterised in that said high-pressure regulator is adapted to permit presetting of an active maximised pressure valid for the return chamber at the end of a piston stroke.

12. The system as claimed in claim 1, characterised in that said low-pressure regulator is adapted to permit presetting of an active minimised pressure valid for the return chamber at the beginning of a piston stroke.

13. The system as claimed in claim 1 or 3, characterised in that said safety valve consists of a non-return valve adapted to bleed the system of air in the event of an emergency stop.

14. The system as claimed in claim 1 or 5, characterised in that an accumulator tank, related to the coupling arrangement, is integrated in said unit or alternatively coupled into said third conduit.

15. The system as claimed in claim 1, characterised in that a selected number of separately controlled piston-cylinder arrangements are, as regards their return chamber, coordinated with one and the same coupling arrangement.

16. The system as claimed in claim 1, characterised in that a selected number of first separately controlled piston-cylinder arrangements are, as regards their return chamber, coordinated and connected to one and the same first coupling arrangement.

17. The system as claimed in claim 1, characterised in that a selected number of second separately controlled piston-cylinder arrangements are, as regards their return chamber, coordinated and connected to one and the same second coupling arrangement.

18. The system as claimed in claim 15 or 16, characterized in that all piston-cylinder arrangements coordinated to a coupling arrangement are dimensioned identically or in any event substantially identically.
